(19) United States
(12) Patent Application Publication
(10) Pub. No.: US 2026/0269369 A1
(43) Pub. Date: Sep. 10, 2026

(54) BATTERY WITH MULTIPLE THERMAL ZONES AND METHOD

(71) Applicant: ASPEN AEROGELS, INC., Northborough, MA (US)

(72) Inventors: Lixin Wang, Northborough, MA (US); Christopher Stow, Northborough, MA (US); John Williams, Northborough, MA (US); Younggyu Nam, Northborough, MA (US)

(21) Appl. No.: 19/126,214

(22) PCT Filed: Nov. 14, 2023
(86) PCT No.: PCT/US2023/037273

§ 371 Date: Apr. 30, 2025

Related U.S. Application Data
(60) Provisional application No. 63/426,639, filed on Nov. 18, 2022.
(60) Provisional application No. 63/538,694, filed on Sep. 15, 2023.

(51) Int. Cl. H01M 10/658; H01M 10/0525; H01M 10/613; H01M 10/647; H01M 10/6551; H01M 10/6554; H01M 50/209; H01M 50/211; H01M 50/293

(52) U.S. Cl. CPC H01M 10/658; H01M 10/0525; H01M 10/613; H01M 10/647; H01M 10/6551; H01M 10/6554; H01M 50/209; H01M 50/211; H01M 50/293

(57) ABSTRACT

A battery’ system, and associated, methods are disclosed. In one aspect, a battery system includes a. stack of battery cells, including two or more different thermal zones. Aspects are shows with two or more different thermal regulating members located between battery cells in the stack of lithium-ion battery cells at dividing location between the thermal zones.

### CLAIM OF PRIORITY

This patent application claims the benefit of priority to U.S. Provisional Patent Application Ser. No. 63/426,639, entitled “BATTERY SYSTEM WITH MULTIPLE THERMAL ISOLATION ZONES AND METHOD,” filed on Nov. 18, 2022, and U.S. Provisional Patent Application Ser. No. 63/538,694, entitled “BATTERY SYSTEM WITH MULTIPLE THERMAL ISOLATION ZONES AND METHOD,” filed on Sep. 15, 2023, each of which are hereby incorporated by reference herein in their entireties.

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery system or pack with one or more battery cells that includes the thermal barrier materials, as well as systems including those battery systems or packs. Aspects described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, operated at or exposed to high temperature and high pressure.

To prevent cascading thermal runaway events from occurring, there is a need for effective insulation and heat dissipation strategies to address these and other technical challenges of LIBs.

### BRIEF DESCRIPTION OF THE DRAWINGS

FIG. 1 shows a battery system in accordance with some aspects.

FIG. 2 shows a battery module in accordance with some aspects.

FIG. 3A shows another battery system in accordance with some aspects.

FIG. 3B shows a cross section from the battery system of FIG. 3A in accordance with some aspects.

FIG. 4A shows another battery system in accordance with some aspects.

FIG. 4B shows a cross section from the battery system of FIG. 4A in accordance with some aspects.

FIG. 4C shows another cross section from the battery system of FIG. 4A in accordance with some aspects.

FIG. 5A shows another battery system in accordance with some aspects.

FIG. 5B shows a cross section from the battery system of FIG. 5A in accordance with some aspects.

FIG. 6 shows a flow chart of a method in accordance with some aspects.

FIG. 7 shows another battery system in accordance with some aspects,

FIG. 8 shows another battery system in accordance with some aspects.

FIG. 9 shows another battery system in accordance with some aspects.

FIG. 10 shows another battery system in accordance with some aspects.

FIG. 11 shows another battery system in accordance with some aspects.

FIG. 12 shows another battery system in accordance with some aspects.

FIG. 13 shows another battery system in accordance with some aspects.

FIG. 14 shows another battery system in accordance with some aspects.

FIG. 15A shows a channel layer in accordance with some aspects.

FIG. 15B shows another channel layer in accordance with some aspects.

FIG. 15C shows another channel layer in accordance with some aspects.

FIG. 16 shows an electronic device in accordance with some aspects.

FIG. 17 shows an electric vehicle in accordance with some aspects.

### DESCRIPTION OF ASPECTS

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

The present disclosure is directed to a thermal regulating member between a stack of battery cells in a battery system. The thermal regulating members divide the housing of the battery system into multiple thermal zones. Each thermal zone may have different thermal regulating members according to the heat distribution characters of the battery cells in the thermal zones. The thermal regulating member comprises an insulating material layer, a thermal conductor plate and a resilient layer. The thermal regulating member is also referred to as thermal barrier, thermal regulating member, thermal regulating element, thermal regulating materials, and thermal regulating layers, or thermal regulating barrier hereafter.

The insulating material layer separates the housing of the battery system into multiple thermal zones to confine, reduce or prevent heat transfer between thermal zones. In some aspects, the insulating material layer includes aerogel. The insulating material layer is therefore also referred to as an aerogel layer hereafter.

The thermal conductor layer dissipates undesired heat away from the battery cells. The thermal conductor layer may also mechanically support the insulating material layer and protect the insulating material from fire and/or particle bombardments during a thermal runaway event. The thermal conductor layer may partially or entirely cover the footprint of the battery cells and/or the insulating material layer.

The resilient layer accommodates battery cell volume expansion and extraction during charge and discharge process. Such accommodations maintain cell pressure and improve electrical chemical performance and cycle life of the battery cells.

The thermal regulating member may further include one or more other functional layers, such as a structural support layer, a glue layer, a heat absorption layer, other functional layers, or combination thereof. Aspects of the structural support layer include polymers, mica, ceramic, resin, rubber, composite materials, other suitable materials, or combinations thereof.

### Insulating Material Layer

Insulation materials, as described in aspects below, can be used as a single heat resistant layer, or in combination with other layers that provide additional function to a multilayer configuration, such as mechanical strength, compressibility, heat dissipation/conduction, etc. Insulation layers described herein are responsible for reliably containing and controlling heat flow from heat-generating parts in small spaces and to provide safety and prevention of heat and fire propagation for such products in the fields of electronic, industrial and automotive technologies.

In many aspects of the present disclosure, the insulation layer functions as a flame/fire deflector layer either by itself or in combination with other materials that enhance performance of containing and controlling heat flow. For example, the insulation layer may itself be resistant to heat, flame and/or hot gases and further include entrained particulate materials that modify or enhance heat containment and control.

One aspect of a highly effective insulation layer includes an aerogel. Aerogels describe a class of material based upon their structure, namely low density, open cell structures, large surface areas (often 900 m²/g or higher) and subnanometer scale pore sizes. The pores may be filled with gases such as air. Aerogels can be distinguished from other porous materials by their physical and structural properties.

Although an aerogel material is an exemplary insulation material, the invention is not so limited. Other thermal insulation material layers may also be used in aspects of the present disclosure.

Selected aspects of aerogel formation and properties are described. In several aspects, a precursor material is gelled to form a network of pores that are filled with solvent. The solvent is then extracted, leaving behind a porous matrix. A variety of different aerogel compositions are known, and they may be inorganic, organic and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain aspects of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one aspect, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

As noted above, an aerogel may be organic, inorganic, or a mixture thereof. In some aspects, the aerogel includes a silica-based aerogel. One or more layers in a thermal barrier may include a reinforcement material. The reinforcing material may be any material that provides resilience, conformability, or structural stability to the aerogel material. Aspects of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

The reinforcement material can be selected from organic polymer-based fibers, inorganic fibers, carbon-based fibers or a combination thereof. The inorganic fibers are selected from glass fibers, rock fibers, metal fibers, boron fibers, ceramic fibers, basalt fibers, or combination thereof. In some aspects, the reinforcement material can include a reinforcement including a plurality of layers of material.

Fiber reinforcement materials can comprise a range of materials, including, but not limited to: Polyesters, polyolefin terephthalates, poly(ethylene) naphthalate, polycarbonates (examples Rayon, Nylon), cotton, (e.g. lycra manufactured by DuPont), carbon (e.g. graphite), polyacrylonitriles (PAN), oxidized PAN, pre-oxidized PAN, uncarbonized heat treated PANs (such as those manufactured by SGL carbon), glass or fiberglass based material (like S-glass, 901 glass, 902 glass, 475 glass, E-glass) silica based fibers like quartz, (e.g. Quartzel manufactured by Saint-Gobain), Q-felt (manufactured by Johns Manville), Saffil (manufactured by Saffil), Durablanket (manufactured by Unifrax) and other silica fibers, Duraback (manufactured by Carborundum), Polyaramid fibers like Kevlar, Nomex, Sontera (all manufactured by DuPont), Conex (manufactured by Taijin), polyolefins like Tyvek (manufactured by DuPont), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by W.L. GORE), Silicon carbide fibers like Nicalon (manufactured by COI Ceramics), ceramic fibers like Nextel (manufactured by 3M), Acrylic polymers, fibers of wool, silk, hemp, leather, suede, PBO-Zylon fibers (manufactured by Tyobo), Liquid crystal material like Vectan (manufactured by Hoechst), Cambrelle fiber (manufactured by DuPont), Polyurethanes, polyamaides, Wood fibers, Boron, Aluminum, Iron, Stainless Steel fibers and other thermoplastics like PEEK, PES, PEI, PEK, PPS.

The glass or fiberglass-based fiber reinforcement materials may be manufactured using one or more techniques. In certain aspects, it is desirable to make them using a carding and cross-lapping or air-laid process. In exemplary aspects, carded and cross-lapped glass or fiberglass-based fiber reinforcement materials provide certain advantages over air-laid materials. For example, carded and cross-lapped glass or fiberglass-based fiber reinforcement materials can provide a consistent material thickness for a given basis weight of reinforcement material. In some embodiments, the fiber reinforcement materials may be manufactured using a wet-laid process. In certain additional aspects, it is desirable to further needle the fiber reinforcement materials with a need to interlace the fibers in z-direction for enhanced mechanical and other properties in the final aerogel composition.

### Thermal Conductor Layer

In addition to thermal insulating layers, thermally conductive layers in combination with thermal insulating layers are effective at channeling unwanted heat to a desired external location, such as external heat dissipating fins, a heat dissipating housing, or other external structure to dissipate unwanted heat to outside ambient air. The thermal conductive layers are also referred to as thermal conductor layer, thermal conductor plate, or thermal conducting layer. In one aspect, a thermally conductive layer or layers helps to dissipate heat away from a localized heat load within a battery system or pack. Aspects of high thermal conductivity materials include carbon fiber, graphite, silicon carbide, metals including but not limited to copper, stainless steel, aluminum, and the like, as well as combinations thereof.

To aid in the distribution and removal of heat by, in at least one aspect the thermally conductive layer is coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. In one aspect, at least one thermally conductive layer of the multilayer materials disclosed herein can be in thermal communication with an element of a cooling system of a battery system or pack, such as a cooling plate or cooling channel of the cooling system. In another aspect, at least one thermally conductive layer of the multilayer materials disclosed herein can be in thermal communication with other elements of the battery pack, battery module, or battery system that can function as a heat sink, such as the walls of the pack, module or system, or with other ones of the multilayer materials disposed between battery cells. Thermal communication between the thermally conductive layer of the multilayer materials and heat sink elements within the battery system can allow for removal of excess heat from the cell or cells adjacent to the multilayer material to the heat sink, thereby reducing the effect, severity, or propagation of a thermal event that may generate excess heat.

### Resilient Layer

In addition to the thermal insulating layers and the thermal conducting layers, the thermal regulating member may further include one or more resilient layers to accommodate the battery cell volume changes during change and discharge. The resilient layer also accommodates mechanical stress placed on the battery system during operation or abuse conditions. In one aspect, the resilient layer may absorb mechanical stresses and strains during the battery pack operation, such as during the driving of an electrical vehicle using the battery system.

Materials for the resilient material layers may include, but are not limited to, foam, fiber, fabric, sponge, spring structures, rubber, polymer, etc. In one aspect, the resilient material layer includes an aerogel layer, such as a monolithic aerogel layer, an aerogel plate, an aerogel blanket, a fiber reinforced aerogel blanket, a foam reinforced aerogel blanket, other aerogel layers, and combinations thereof. In one aspect, the resilient material layer may be a polyurethane foam. In one aspect, the resilient layer may be compressed and bounce back from 5% to 95%, 10% to 90%, 30% to 90%, 40% to 85%, 60% to 80%, or any of the percentages ranges described herein of its original thickness.

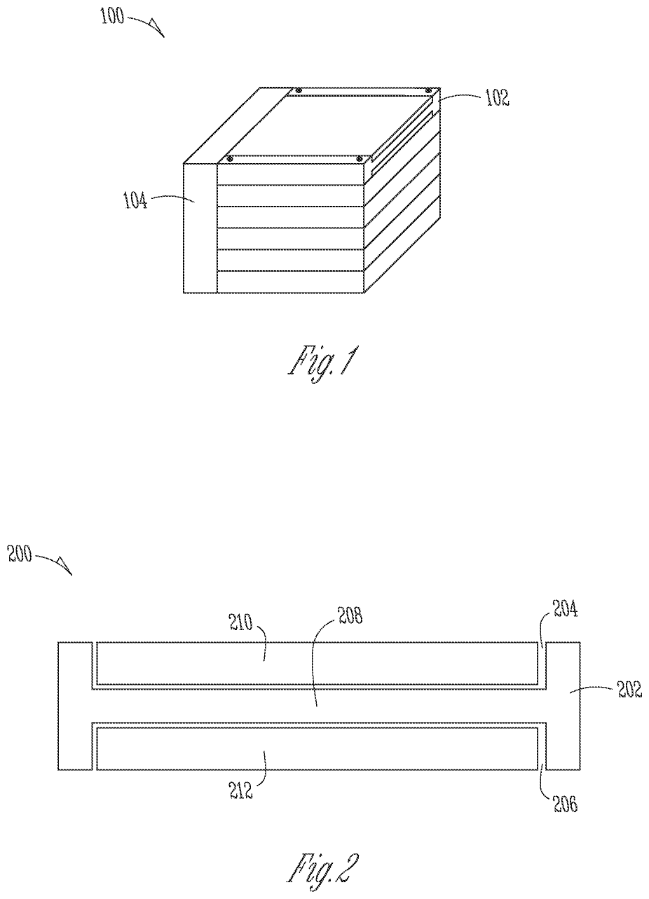

FIG. 1 shows one aspect of a battery system 100. The system 100 includes one or more battery modules 102. In the aspect of FIG. 1, each module includes a carrier frame and two batteries. A heat sink 104 is shown located on a side of the system 100, and in thermal communication with the battery modules 102.

FIG. 2 shows a cross section of a battery module 200 similar to battery module 102 from FIG. 1. A first battery 210 and a second battery 212 are shown. A carrier frame 202 includes a first cavity 204 and a second opposing cavity 206. The first battery 210 and the second battery 212 are shown located at least partially within the the first cavity 204 and the second cavity 206. In one aspect, the batteries 210, 212 may be selected from different cell formats, such as prismatic, cylindrical, pouch, other cell formats, or combinations thereof. The battery cells 102 may be selected from different cell chemistries, such as lithium ion, sodium ion, other alkaline ion, nickel manganese cobalt battery, lithium ion phosphate battery, anode-less battery, semi-solid state battery, solid state battery, other battery chemistries, or combinations thereof. Lithium ion pouch cells are frequently used in electric vehicle battery systems. A central separator 208 is shown located between the pair of opposing cavities 204, 206.

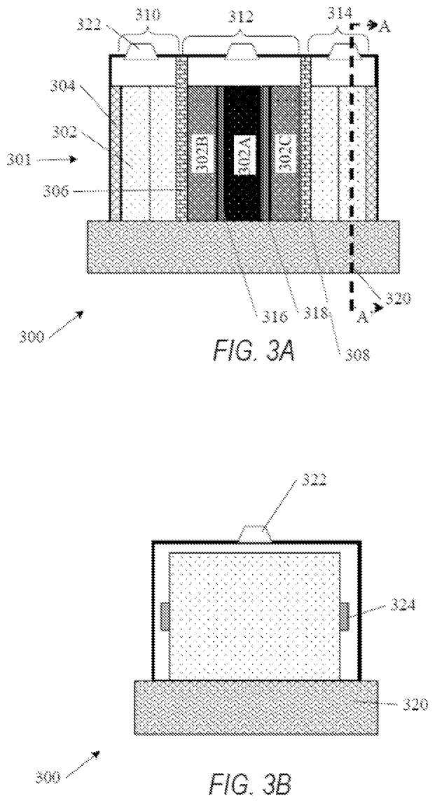

FIG. 3A shows an aspect of a battery system 300. The system 300 includes a stack 301 of battery cells 302. In one aspect, the battery cells 302 include lithium-ion cells, although the invention is not so limited. A heat sink 320 is included in the system 300 of FIG. 3A located on a side of the stack of battery cells 302. The stack of battery cells 302 includes two or more different thermal zones. Each thermal zone includes at least one battery cell module similar to the battery cell module 102 in FIG. 1 or the battery cell module 200 in FIG. 2. In some aspects, at least one thermal zone has a battery cell 302A sandwiched between battery cells 302B and 302C. In one aspect, the battery cells 302A, 302B, and 302C each have different battery chemistries. In one aspect, the battery cell 302A is a LFP battery cell while the battery cells 302B and 302C are anode-free batteries.

The different thermal zones are separated by thermal regulating members. The thermal regulating members prevent venting gas, particles, and heat from migrating to adjacent thermal zones at the event of thermal runaway. In the aspect of FIG. 3A, a first thermal zone 310 is located adjacent sides of the stack 301. A second thermal zone 312 is located closer to a middle of the stack 301. Although two zones 310, 312 are shown, the invention is not so limited. Multiple zones are possible within the scope of the invention.

In operation, different locations of battery cells 302 within the stack 301 may dictate different thermal management needs. For example, battery cells at an edge of the stack 301 do not have other battery cells of both sides. This may lead to less heat for removal or regulation from edge cells. Also, battery cells in a more central location within the stack 301 may retain more heat due to the proximity to more battery cells on either side of a given centrally located battery cell 302. Other factors, such as adjacent structures to the battery system 300 causing a local insulating or cooling effect may dictate where zones 310, 312, etc. are divided.

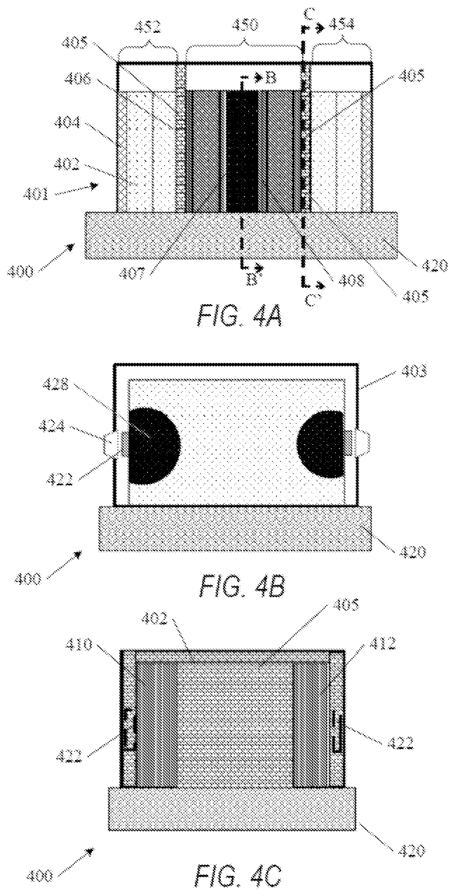

A battery pack or battery module may have two or more thermal zones. The two or more thermal zones may have different temperatures during charge and discharge of the battery cells. One or more of the thermal zones may have conductive plates. For example, the thermal zone with highest temperature may have conductive plates (e.g., 410 and 412 from FIG. 4C) to promote heat conduction to the heat sink 320. the thermal zones more prone to thermal runaway also include heat conductive plates. The thermal zones with heat conductive plates may be in the middle of the battery module or any other location in the battery module.

A number of different thermal regulating members are shown in FIG. 3A. The number of different thermal regulating members are configured to provide different heat transfer properties to adjacent different thermal zones. A resilient material member 304 is shown at an exterior surface of the stack 301. A first thermal regulating member 306 is shown between the first thermal zone 310 and the second thermal zone 312. A second thermal regulating member 308 is shown between the second thermal zone 312 and a third thermal zone 314. Although three thermal zones 310, 312, 314 and two thermal regulating members 306, 308 are shown, the invention is not so limited. One of ordinary skill in the art, having the benefit of the present disclosure, will recognize that fewer than three thermal zone, or more than three thermal zones, and respective thermal regulating members are also possible.

In one aspect, different thermal regulating members include different materials. In one aspect, different thermal regulating members include different geometries or configurations with a same material. In one aspect, different thermal regulating members include different layers within a battery system 300. In one aspect, different thermal regulating members include one type of layer (e.g., layers 316 and 318) at a first location of the battery system 300, and a different type of thermal regulating member (e.g. 306 and 308) at a second location of the battery system 300. For example, a first location may include a heat conductive layer (e.g. a metallic layer), providing high thermal conductivity, while a second location may include an insulating layer, such as an aerogel layer. The different layers may be oriented towards different adjacent thermal zones that best suit the provided properties of the layers.

In one aspect, an insulating layer seals the individual thermal zones to prevent or reduce heat or venting gas from migrating to adjacent thermal zones. In one aspect, the thermal regulating member (e.g. 306 and 308) has a large surface that is the same or similar as the cross sectional surface of the interior of the battery module or pack to block the thermal runaway heat, gas, and particles. In one aspect, a heat conductive layer (e.g., layers 316 and 318) has the same or similar surface as the battery cell, which may be smaller than the cross sectional surface of the interior of the battery module or pack.

In one aspect a layer of resilient material is included in one or more of the thermal zones. For example, the layers 316 and 318 may be resilient material layers instead of heat conductive layers in FIG. 3A. In operation, thermal expansion and electrochemical expansion may cause battery cells 302 to expand and contract within the stack 301. Inclusion of one or more resilient material layers within different thermal regulating members provides a mechanism to accommodate swelling and contraction. Aspects of resilient material layers includes, but are not limited to foams, polymers, foamed polymer layers, polyurethane foam, metal mesh layers, rubber, wool, cotton, other resilient material layers, or combinations thereof.

One thermal regulating material includes a heat conducting material. For example, the layers 316 and 318 may be heat conducting materials, such as copper, aluminum, steel, carbon fiber, graphene, graphite, silicon carbide, other heat conductive materials, and combinations thereof. Metal materials are typically good thermal conductors, but add to a weight of a battery system.

Another property that can be considered in a choice of different thermal regulating members is an ability for thermal isolation. Some materials may decompose or melt under the heat of a thermal runaway in a battery cell. By choosing different thermal regulating members for different positions adjacent to different thermal zones, thermal needs can be managed more effectively in locations (e.g., thermal zone 312) within the stack 301 where thermal runaway is more likely. For example, combinations of both the thermal isolation and heat conduction layers can be used in these thermal runaway prone zones. At the same time, locations (e.g., thermal zones 310 or 314) within the stack 301 that are less likely for thermal runaway can be protected with less heavy or less expensive thermal regulating members. For example, heat conductive plates may not be needed in these less prone zones for thermal runaway.

FIGS. 3A and 3B further include one or more vents 322. A thermal runaway event may generate combustion gasses. Example systems 300 that include one or more vents 322 can dissipate the combustion gasses in the event of a thermal runaway. In one aspect, each thermal zone 310, 312, 314 may include a vent 322. In one aspect, a vent 322 is only included with thermal zones at high risk for a thermal runaway, such as the thermal zone 312.

FIG. 3B is a cross sectional view of FIG. 3A along line AA′. In FIG. 3B, the vent 322 is shown adjacent to a side of the battery cell 302 that is spaced apart from an electrode tab 324. Other aspects, as shown in aspects below, include the vent 322 adjacent to the tab 324. In one aspect, a region adjacent to a tab 324 is more probe to overheating, and a location of a vent 322 adjacent to the tab 324 is advantageous.

FIG. 4A shows an aspect of a battery system 400. The system 400 includes a stack 401 of battery cells 402. In one aspect, the battery cells 402 include lithium-ion battery cells, although the invention is not so limited. A heat sink 420 is included in the system 400 of FIG. 4A located on a side of the stack of battery cells 402. Similar to the aspect of FIGS. 3A and 3B, the system 400 includes a number of different thermal regulating members. A resilient material layer 404 is shown at an exterior surface of the stack 401. A first thermal regulating member 406 is shown between battery cells 402 in the stack 401, and a second thermal regulating member 408 is shown closer to a middle of the stack 401 of battery cells 402.

The first thermal regulating member 406 includes two layers 405 and 407. In one aspect, a first layer 405 includes a thermal insulation layer, and a second layer 407 includes a thermal conducting layer. As discussed above, the thermal insulating layer 405 may be oriented to face a thermal zone (e.g., 450) where insulating is more advantageous than conduction, and the thermal conducting layer 407 may be oriented towards a thermal zone where heat conduction towards the heat sink 420 is more advantageous.

Although the aspect of FIG. 4A shows the second layer 407 (thermal conducting layer) located directly adjacent to the first layer 405, the invention is not so limited. In one aspect, layers 405 are thermal insulating layers that define a middle thermal zone 450 that has higher heat dissipation needs than a side zone 452. One or more thermal conducting layers (407, 408) are included within the middle zone 450 where they are more needed. Fewer thermal conducting layers, or no thermal conducting layers are included in other thermal zones such as zones 452 and 454.

FIG. 4B shows a cross section of a selected battery cell 402 from FIG. 4A along line BB′. An electrode tab 422 is shown on an edge of the battery cell 402. A hot zone 428 is shown adjacent to the tab 422. In many battery cells 402, a tab region is particularly susceptible to higher temperatures during operation. As discussed above, in one aspect, a vent 424 is located directly adjacent to the tab 422 to anticipate possible thermal runaway from the hot zone 428.

FIG. 4C shows a cross section view of a thermal regulating member according along line CC′ to one aspect. The thermal regulating member includes a first thermal conductor plate 410 that forms a direct interface with only a fraction of an area of an adjacent battery cell. In FIG. 4C, the thermal conductor plate 410 aligns with one of the hot zones 428 from FIG. 4B. A second thermal conductor plate 412 is further included in the aspect of FIG. 4C to correspond to the other hot zone 428 adjacent to tabs 422 from FIG. 4B. A heat isolation layer 405 is further shown coupled to the conductor plates 410, 412, and separating thermal zones in the module. In one aspect, the heat isolation layer 405 is larger than the battery cell 402 and fills an interior cross section of battery module housing 403.

Configurations as shown in FIG. 4C can provide thermal conduction where needed in hot zones, such as tab 422, while reducing weight of an overall battery system 400 by reducing an amount of conductor plate, which is typically made from heavier materials such as metal. The thermal conductor plates 410 and 412 conduct the heat from hot zones 428 to the heat sink 420, therefore, prevent hot zones 428 to be triggers of thermal runaway. Selected inclusion of heat isolation layers further provides safety by isolating adjacent battery cells 402 in the stack 401. Although locations for conductor plates 410, 412 are shown next to the tab 422, the invention is not so limited. Conductor plates that forms a direct interface with only a fraction of an area of an adjacent battery cell may include a single conductor plate, or more than two portions of conductor plates. Locations can include any area of a battery cell that generates high heat, and will benefit from preferential conduction to a heat sink 420.

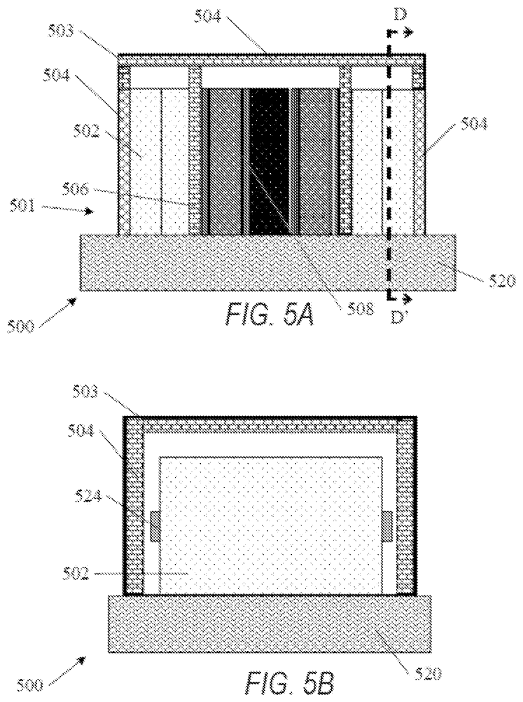

FIGS. 5A and 5B show an aspect of a battery system 500, The system 500 includes a stack 501 of battery cells 502. In one aspect, the battery cells 502 include lithium-ion battery cells, although the invention is not so limited. A heat sink 520 is included in the system 500 of FIG. 5A located on a side of the stack of battery cells 502. Similar to other aspects described above, the system 500 includes a number of different thermal regulating members. A first thermal regulating member 504 is shown at an exterior surface of the stack 501. A second thermal regulating member 506 is shown between battery cells 502 in the stack 501, and a third thermal regulating member 508 is shown closer to a middle of the stack 501 or battery cells 502. Tabs 524, similar to tabs described in other aspects are shown on edges of a given battery cell 502.

In the aspect of FIGS. 5A and 5B, the resilient material member 504 lines an interior of a battery module housing 503. Figure SB is a cross section view of FIG. 5A along line DD′ across one of the thermal zones. In one aspect, the first thermal regulating member 504 lines an interior of a battery pack or module. One advantage of this configurations includes an increased ability to contain a thermal runaway condition to the system 500, without spreading to adjacent locations, such as a passenger area within an electric vehicle. By utilizing different thermal regulating members, heat can be managed and directed to the heat sink 520 during normal operation. In the event of a thermal runaway, the first thermal regulating member 504 contains or slows any fire or dangerous heat within the thermal zones of the battery system 500.

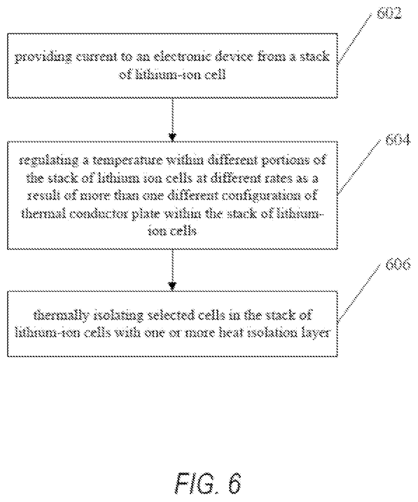

FIG. 6 shows a flow diagram of an example method of operation for an electronic device utilizing a battery system as described. In operation 602, current is provided to an electronic device from a stack of lithium-ion battery cells. In operation 604, a temperature is regulated within different portions of the stack of lithium ion battery cells at different rates as a result of more than one different configuration of thermal conductor plate within the stack of lithium-ion battery cells. In operation 606, selected battery cells in the stack of lithium-ion battery cells are thermally isolated with one or more heat isolation layer.

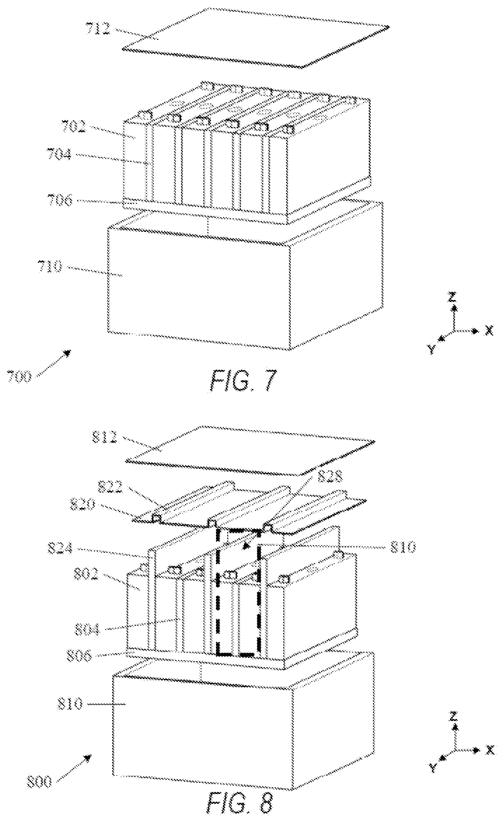

FIG. 7 shows another battery system 700 according to some aspects of the present disclosure. The battery system 700 includes a number of battery cells 702. One or more intermediate structures 704 are included between battery cell 702. In one aspect, the intermediate structures 704 include thermal barriers. In one aspect the intermediate structures 704 include conductor plates. In one aspect, conductor plates channel heat away from the battery cells 702 to a cooling plate 706. In one aspect, the intermediate structures 704 include a resilient layer. The battery system 700 of FIG. 7 may optionally include a housing 710 and a lid 712 to contain the battery cells 702 and other battery system 700 components.

FIG. 8 shows another battery system 800 according to some aspects of the present disclosure. The battery system 800 includes a number of battery cells 802. One or more intermediate structures 804 are optionally included between battery cells 802. In one aspect, the intermediate structures 804 include thermal barriers. In one aspect the intermediate structures 804 include conductor plates. In one aspect, conductor plates channel heat away from the battery cells 802 to a cooling plate 806. The battery system 800 of FIG. 8 may optionally include a housing 810 and a lid 812 to contain the battery cells 802 and other battery system 800 components.

The battery system 800 of FIG. 8 further includes one or more extended thermal barriers 824. The extended thermal barriers 824 each have a larger footprint than each of the battery cells 802. In one aspect, the extended thermal barriers 824 include an aerogel. In one aspect, the extended thermal barriers 824 are a single layer. In one aspect, the extended thermal barriers 824 include multiple layers laminated together. One advantage of incorporating extended thermal barriers 824 into the battery system 800 includes dividing the housing 810 into multiple thermal zones, such as thermal zone 811 indicated by the dashed box. In some thermal runaway events, flames, gasses and ejecta are expelled into the top spaces 828 of the thermal zones between battery cells 802. The top spaces 828 are the spaces between the top of the battery cells 802, the end plate 820 and the extended portions of the thermal barriers 824. Inclusion of extended thermal barriers 824 better contains any flames, gasses and ejecta in the top spaces 828 between battery cells 802.

In some configurations, The battery system 800 of FIG. 8 further includes an end plate 820 including one or more slots 822 that are positioned to correspond to the extended thermal barriers 824. When assembled, the one or more slots 822 hold distal ends of the extended thermal barriers 824 in place, and provide enhanced structural strength for the thermal zones to contain flames, gasses and ejecta in the top spaces 828 of the thermal zone between battery cells 802. A number of material selections are effective for the end plate 820. Materials may include heat, flame, and particle resistant materials including, but not limited to, mica, metals, polymers, aerogel, and dielectric materials. The end plate 820 may be a single continuous material, such as a stamped metal, or include multiple laminated layers, or include a composite material such as a fiber reinforced material, etc.

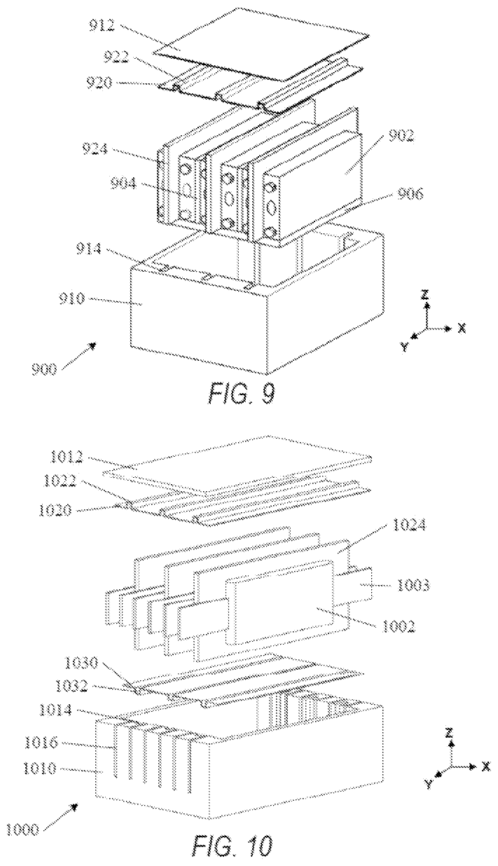

FIG. 9 shows another battery system 900 according to some aspects of the present disclosure. The battery system 900 includes a number of battery cells 902. One or more intermediate structures 904 are optionally included between battery cells 902. In one aspect, the intermediate structures 904 include thermal barriers. In one aspect the intermediate structures 904 include conductor plates. In one aspect, conductor plates channel heat away from the battery cells 902 to a cooling plate 906. The battery system 900 of FIG. 9 may optionally include a housing 910 and a lid 912 to contain the battery cells 902 and other battery system 900 components.

The battery system 900 of FIG. 9 further includes one or more extended thermal barriers 924. In one aspect, the extended thermal barriers 924 include an aerogel. In one aspect, the extended thermal barriers 924 are a single layer. In one aspect, the extended thermal barriers 924 include multiple layers laminated together. The battery system 900 of FIG. 9 further includes an end plate 920 including one or more slots 922 that are positioned to correspond to the extended thermal barriers 924. When assembled, the one or more slots 922 hold distal portions of the extended thermal barriers 924 in place, and provide enhanced structural support to contain flames, gasses and ejecta in spaces between battery cells 902. Similar to aspects described above, materials for the end plate 920 may include metals, polymers, minerals such as mica, aerogel or other dielectric materials.

In the aspect of FIG. 9, a number of housing slots 914 in the housing 910 are configured to further engage side extension portions of the extended thermal barriers 924. This configuration provides additional structural support to the extended thermal barriers 924, and further encloses side portions of the battery cells 802. The extended thermal barriers 924 divide the housing 910 into multiple thermal zones.

FIG. 10 shows another battery system 1000 according to some aspects of the present disclosure. The battery system 1000 includes a number of battery cells 1002. One or more intermediate structures may be optionally included between battery cells 1002. In one aspect, the intermediate structures include thermal barriers. In one aspect the intermediate structures include conductor plates. In one aspect, conductor plates channel heat away from the battery cells 1002 to a cooling plate. The battery system 1000 of FIG. 10 may optionally include a housing 1010 and a lid 1012 to contain the battery cells 1002 and other battery system 1000 components.

The battery system 1000 of FIG. 10 further includes one or more extended thermal barriers 1024. In one aspect, the extended thermal barriers 1024 include an aerogel. In one aspect, the extended thermal barriers 1024 are a single layer. In one aspect, the extended thermal barriers 1024 include multiple layers laminated together. The battery system 1000 of FIG. 10 further includes an end plate 1020 including one or more slots 1022 that are positioned to correspond to the extended thermal barriers 1024. When assembled, the one or more slots 1022 hold distal portions of the extended thermal barriers 1024 in place, and provide enhanced structural support to contain flames, gasses and ejecta in spaces between battery cells 1002. Similar to aspects described above, materials for the end plate 1020 may include aerogel, metals, polymers, minerals such as mica, or other dielectric materials.

In the aspect of FIG. 10, a second end plate 1030 is further included with one or more slots 1032 that are positioned to correspond to the extended thermal barriers 1024. In this way, both the top and bottom extensions of the extended thermal barriers 1024 are engaged with, and supported by the end plate 1020, and the second end plate 1030.

In the aspect of FIG. 10, a number of housing slots 1014 in the housing 1010 are configured to further engage side extension portions of the extended thermal barriers 1024. This configuration provides additional structural support to the extended thermal barriers 1024, and further encloses side portions of the battery cells 1002.

In the aspect of FIG. 10, the number of battery cells 1002 include pouch battery cells that each include electrode tabs 1003. The aspect of FIG. 10 further includes electrode slots 1016 in the housing 1010 to accommodate the electrode tabs 1003.

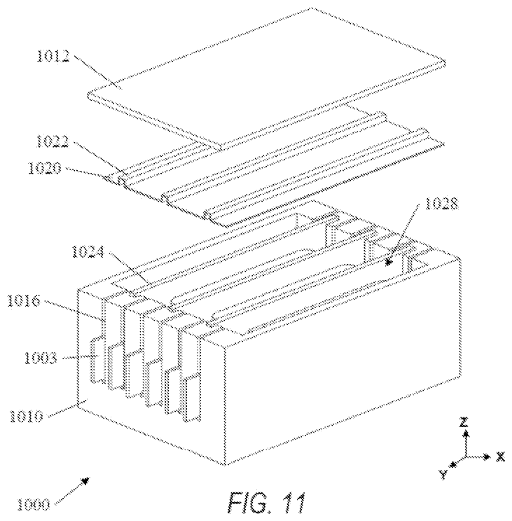

FIG. 11 shows the battery system 1000 from FIG. 10 in a further level of assembly. The electrode tabs 1003 are shown within the electrode slots 1016 in the housing 1010. In an end use device, such as an electric vehicle, further structure, such as a bus bar (not shown) will be coupled to the portion of the electrode tabs 1003 that extend beyond sides of the housing 1010. The extended thermal barriers 1024 are shown defining top spaces 1028 between battery cells 1002.

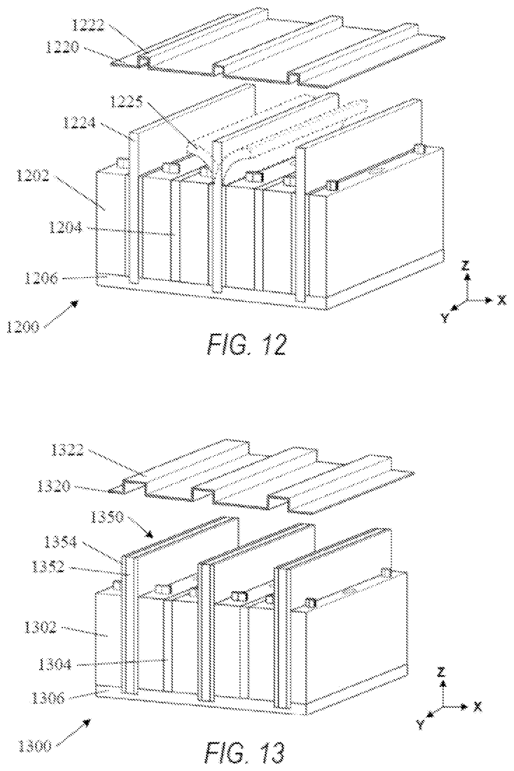

FIG. 12 shows another battery system 1200 according to some aspects of the present disclosure. The battery system 1200 includes a number of battery cells 1202. One or more intermediate structures 1204 are optionally included between battery cells 1202. In one aspect, the intermediate structures 1204 include thermal barriers. In one aspect the intermediate structures 1204 include conductor plates. In one aspect, conductor plates channel heat away from the battery cells 1202 to a cooling plate 1206.

The battery system 1200 of FIG. 12 further includes one or more extended thermal barriers 1224. In one aspect, the extended thermal barriers 1224 include an aerogel. In one aspect, the extended thermal barriers 1224 are a single layer. In one aspect, the extended thermal barriers 1224 include multiple layers laminated together. The battery system 1200 of FIG. 12 further includes an end plate 1220 including one or more slots 1222 that are positioned to correspond to the extended thermal barriers 1224. When assembled, the one or more slots 1222 hold distal portions of the extended thermal barriers 1224 in place, and provide enhanced structural support to contain flames, gasses and ejecta in spaces between battery cells 1202.

In the aspect of FIG. 12, the extended thermal barriers 1224 are illustrated as flexible. Potential flexed conditions 1225 are illustrated in dashed lines. One advantage of flexible extended thermal barriers 1224 includes the ability to more easily engage with the slots 1222 in the end plate 1020. In practice, it may be difficult to account for manufacturing tolerances when locating slots 1222 and extended thermal barriers 1224 within the battery system 1200. The ability of the extended thermal barriers 1224 to flex reduces or eliminates the need for exact alignment between slots 1222 and extended thermal barriers 1224. Any given extended thermal barrier 1224 can flex an individual amount to align with its corresponding slot 1222. The flexibility of the extended thermal barrier 1224 also prevents or reduces possible mechanical damage during operation of the battery systems 1200, such as from cell swelling and contraction during charge/discharge cycles, cell expansion over the lifetime of the battery system or from movement of the cells within the system, e.g., while driving of an electrical vehicle using the battery systems 1200,

FIG. 13 shows another battery system 1300 according to some aspects of the present disclosure. The battery system 1300 includes a number of battery cells 1302. One or more intermediate structures 1304 are optionally included between battery cells 1302. In one aspect, the intermediate structures 1304 include thermal barriers. In one aspect the intermediate structures 1304 include conductor plates. In one aspect, conductor plates channel heat away from the battery cells 1302 to a cooling plate 1306. In one aspect, the intermediate structures 1304 include resilient layers.

The battery system 1300 of FIG. 13 further includes one or more extended thermal barriers 1350. In one aspect, the extended thermal barriers 1350 include an aerogel. The battery system 1300 of FIG. 13 further includes an end plate 1320 including one or more slots 1322 that are positioned to correspond to the extended thermal barriers 1350. When assembled, the one or more slots 1322 hold distal portions of the extended thermal barriers 1350 in place, and provide enhanced structural support to contain flames, gasses and ejecta in spaces between battery cells 1302.

The one or more extended thermal barriers 1350 of FIG. 13 are laminate structures. A thermal insulator layer 1352 is included with at least one rigid layer 1354. In one aspect, the thermal insulator layer 1352 is located between a pair of rigid layers 1354, to provide rigid protection from either side of the extended thermal barriers 1350. In one aspect, the thermal insulator layer 1352 includes an aerogel. In one aspect, the rigid layer 1354 includes mica, polymers, ceramic, resin, rubber, composite materials, other suitable materials, metal, copper, stainless steel, aluminum, carbon fiber, graphene, graphite, silicon carbide, other rigid materials, or combinations thereof. In practice, flames, gasses, and ejecta may be abrasive. While the thermal insulator layer 1352 may contain heat well, it may not be as effective at resisting erosion and particle bombardments from abrasive ejecta. The addition of the rigid layer 1354 may provide increased resistance to erosion and particle bombardments, while the thermal insulator layer 1352 provides increased resistance to heat transfer. As noted above, one aspect of rigid layer 1354 includes mica. Mica may be continuous, or may include mica particles suspended in a silicone matrix to form a mica composite. Other materials suitable to resist erosion and particle bombardments include, but are not limited to, metals, dielectric materials, rigid polymers, etc.

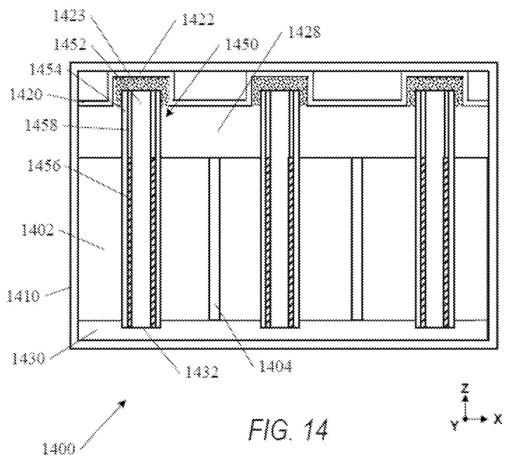

FIG. 14 shows another battery system 1400 according to some aspects of the present disclosure. The battery system 1400 includes a number of battery cells 1402. One or more intermediate structures 1404 are optionally included between battery cells 1402. In one aspect, the intermediate structures 1404 include thermal barriers. In one aspect the intermediate structures 1404 include conductor plates. In one aspect the intermediate structures 1404 include resilient layers. The battery system 1400 of FIG. 14 may optionally include a housing 1410 to contain the battery cells 1002 and other battery system 1000 components.

The battery system 1400 of FIG. 14 further includes one or more extended thermal barriers 1450. In one aspect, the extended thermal barriers 1450 include an aerogel. The battery system 1400 of FIG. 14 further includes an end plate 1420 including one or more slots 1422 that are positioned to correspond to the extended thermal barriers 1450. When assembled, the one or more slots 1422 hold distal portions of the extended thermal barriers 1450 in place, and provide enhanced structural support to contain flames, gasses and ejecta in spaces 1428 between battery cells 1402. The aspect of FIG. 14 further includes a second end plate 1430 including one or more slots 1432. In one aspect, the second end plate 1430 includes a dielectric material. In one aspect, the second end plate 1430 includes a metal and functions as a cooling plate.

Similar to the aspect of FIG. 13, the one or more extended thermal barriers 1450 of FIG. 14 are laminate structures. A thermal insulator layer 1452 is included with at least one rigid layer 1454. In one aspect, the thermal insulator layer 1452 is located between a pair of rigid layers 1454, to provide rigid protection from either side of the extended thermal barriers 1450. In one aspect, the thermal insulator layer 1452 includes an aerogel. In one aspect, the rigid layer 1454 includes mica. Similar to the aspect of FIG. 13, the addition of the rigid layer 1454 may provide increased resistance to erosion and particle bombardments, while the thermal insulator layer 1452 provides increased resistance to heat transfer.

The one or more extended thermal barriers 1450 of FIG. 14 further include an adhesive 1456 to hold the rigid layer 1454 to the thermal insulator layer 1452. In one aspect, the adhesive 1456 only occupies a portion of an interface between the rigid layer 1454 and the thermal insulator layer 1452. FIG. 14 further shows an unsecured interface 1458, such as an air gap, or merely an absence of adhesive 1456. The unsecured interface 1458 allows a top portion of the extended thermal barrier 1450 to better flex from side to side. This allows the extended thermal barrier 1450 to more easily mate with corresponding slots 1422. The flexibility of the extended thermal barrier 1450 also prevents or reduces possible mechanical damage during operation of the battery systems 1400, such as from cell swelling and contraction during charge/discharge cycles, cell expansion over the lifetime of the battery system or from movement of the cells within the system, e.g., while driving of an electrical vehicle using the battery systems 1400.

The battery system 1400 of FIG. 14 further includes one or more slots 1422 that are wider than the extended thermal barriers 1450. This also allows the extended thermal barrier 1450 to more easily mate with corresponding slots 1422. FIG. 14 further includes a sealant 1423 within the slots 1422 to provide a seal to flames, gasses, ejecta, etc. while still providing an more relaxed tolerance for aligning the extended thermal barriers 1450 with slots 1422. In one aspect, the sealant 1423 includes intumescent materials which can expand and further seal the slots 1422 and adjacent spaces. The intumescent materials prevent heat, fire, and ejecta from travelling to adjacent thermal zones during thermal runaway.

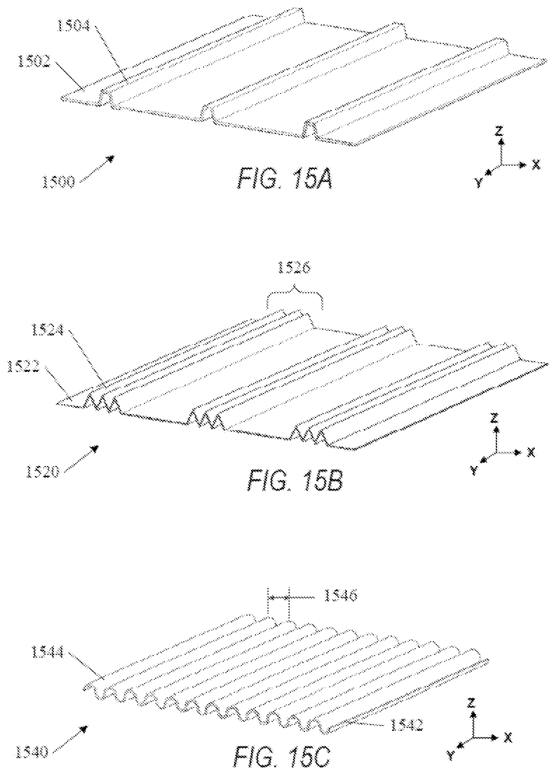

FIGS. 15A-51C show selected aspects of end plates that may be used in battery system aspects described above. FIG. 15A shows an end plate assembly 1500 including a plate 1502 with a number of channels 1504. The channels 1504 include a trapezoidal cross section geometry. In one aspect, a trapezoidal cross section geometry aids in directing extended thermal barriers into the channels 1504 during assembly.

FIG. 15B shows another aspect of an end plate assembly 1520 including a plate 1522 with a number of channels 1524. In the aspect of FIG. 15B, multiple channels 1524 are included in a number of channel regions 1526. Each channel region 1526 is located in a battery system to correspond with an extended thermal barrier. Channels 1524 each has a triangle cross section geometry for easier manufacturing. Portions of the end plate assembly 1500 are free from channels. By including multiple channels 1524 with each channel region 1526, a corresponding extended thermal barrier may slot into any channel 1524 within the channel region 1526. This provides multiple options for each extended thermal barrier and reduces necessary manufacturing tolerances when locating components such as extended thermal barriers and channels.

FIG. 15C shows another aspect of an end plate assembly 1540 including a plate 1542 with a number of channels 1544. The end plate assembly 1540 has a sine wave shaped cross section geometry. In one aspect, the sine wave shaped channels are distributed throughout the entire end plate assembly 1540. The channels 1544 are formed on a pitch 1546. In one aspect, more channels 1544 are included than there are corresponding extended thermal barriers. This configuration also reduces necessary manufacturing tolerances when locating components such as extended thermal barriers and channels. In one aspect, the pitch 1546 is selected such that any given extended thermal barrier is flexible enough to successfully engage a channel 1544. Exact locations of channels 1544 are therefore not critical, and still each extended thermal barrier will be able to engage a channel 1544 to provide additional support to the extended thermal barrier as described above.

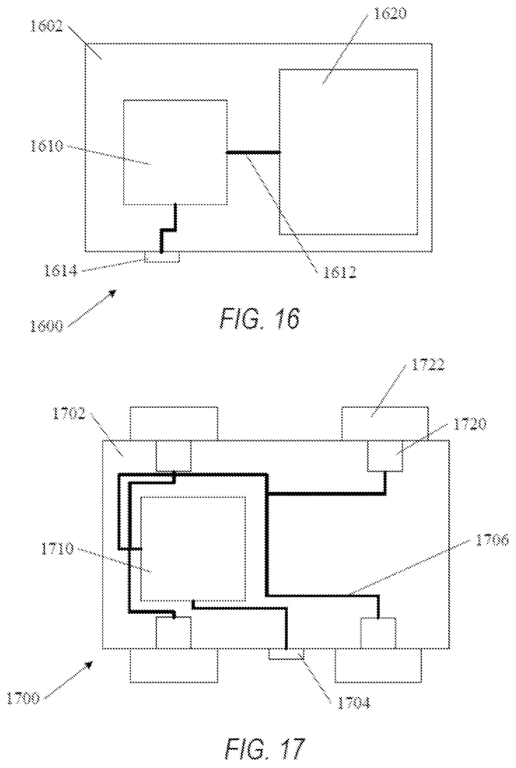

Battery systems as described above are used in a number of electronic devices. FIG. 16 illustrates an aspect electronic device 1600 that includes a battery system 1610. The battery system 1610 is coupled to functional electronics 1620 by circuitry 1612. In the aspect shown, the battery system 1610 and circuitry 1612 are contained in a housing 1602. A charge port 1614 is shown coupled to the battery system 1610 to facilitate recharging of the battery system 1610 when needed.

In one aspect, the functional electronics 1620 include devices such as semiconductor devices with transistors and storage circuits. Aspects include, but are not limited to, telephones, computers, display screens, navigation systems, etc.

FIG. 17 illustrates another electronic system that utilizes battery systems that include multilayer thermal barriers as described above. An electric vehicle 1700 is illustrated in FIG. 17. The electric vehicle 1700 includes a chassis 1702 and wheels 1722. In the aspect shown, each wheel 1722 is coupled to a drive motor 1720. A battery system 1710 is shown coupled to the drive motors 1720 by circuitry 1706. A charge port 1704 is shown coupled to the battery system 1710 to facilitate recharging of the battery system 1710 when needed.

Aspects of electric vehicle 1700 include, but are not limited to, consumer vehicles such as cars, trucks, etc. Commercial vehicles such as tractors and semi-trucks are also within the scope of the invention. Although a four wheeled vehicle is shown, the invention is not so limited. For aspect, two wheeled vehicles such as motorcycles and scooters are also within the scope of the invention.

To better illustrate the method and apparatuses disclosed herein, a non-limiting list of aspects is provided here:

Aspect 1. A battery system, comprising: a stack of lithium-ion battery cells, including two or more different thermal zones; two or more different thermal regulating members located between battery cells in the stack of lithium-ion battery cells at dividing location between the thermal zones; wherein the different thermal regulating members are configured to provide different heat transfer properties to adjacent different thermal zones.

Aspect 2. The battery system of aspect 1, wherein a first thermal regulating member of the different thermal regulating members is configured to cool middle battery cells of the stack of lithium-ion battery cells faster than end battery cells.

Aspect 3. The battery system of aspect 1, wherein opposing sides of a given thermal regulating member provide different heat transfer properties.

Aspect 4. The battery system of aspect 1, wherein at least one of the different thermal regulating members includes an aerogel heat isolation layer.

Aspect 5. The battery system of aspect 1, wherein at least one of the different thermal regulating members includes a resilient layer.

Aspect 6. The battery system of aspect 1, further including one or more vents from a thermal zone.

Aspect 7. The battery system of aspect 1, wherein the stack of lithium-ion battery cells includes a stack of lithium-ion pouch battery cells.

Aspect 8. A battery system, comprising: a stack of lithium-ion battery cells, including two of more different thermal zones; a thermal regulating member located between battery cells in the stack of lithium-ion battery cells, the thermal regulating member comprising; a thermal conductor plate that forms a direct interface with only a fraction of an area of an adjacent lithium-ion battery cell; and a heat isolation layer.

Aspect 9. The battery system of aspect 8, wherein the thermal conductor plate includes a pair of conductor plates over only tab regions of a lithium-ion battery cell.

Aspect 10. The battery system of aspect 8, wherein the heat isolation layer includes an aerogel layer.

Aspect 11. The battery system of aspect 8, further including a heat sink coupled to a side of the stack of lithium-ion battery cells.

Aspect 12. The battery system of aspect 8, further including a vent coupled to a zone defined by the thermal regulating member.

Aspect 13. A method of operating a battery system, comprising: providing current to an electronic device from a stack of lithium-ion battery cells; regulating a temperature within different portions of the stack of lithium-ion battery cells at different rates as a result of more than one different configuration of thermal conductor plate within the stack of lithium-ion battery cells; and thermally isolating selected battery cells in the stack of lithium-ion battery cells with one or more heat isolation layer.

Aspect 14. The method of aspect 13, wherein regulating a temperature includes conducting heat from tab portions of one or more lithium-ion battery cells using conductor plates that include a gap over central areas of the stack of lithium-ion battery cells.

Aspect 15. The method of aspect 13, wherein regulating a temperature includes conducting heat from battery cells at a middle of the stack of lithium-ion battery cells faster than end battery cells.

Aspect 16. A battery system, comprising: a battery housing; a stack of battery cells within the battery housing; one or more extended thermal barriers between selected battery cells in the stack of battery cells; and an end plate, including one or more channels, wherein the one or more extended thermal barriers are located within the one or more channels.

Aspect 17. The battery system of aspect 16, wherein the one or more channels are grouped in a channel region adjacent to an extended portion of the one or more extended thermal barriers.

Aspect 18. The battery system of aspect 16, wherein the end plate includes a trapezoidal cross section geometry.

Aspect 19. The battery system of aspect 16, wherein the one or more extended thermal barriers comprise a heat insulating layer and a rigid layer, both of which are located within the one or more channels.

Aspect 20. The battery system of aspect 16, wherein the battery housing comprises one or more housing slots, and wherein an extended portion of the one or more extended thermal barriers is located in the one or more housing slots.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are entitled.

Although an overview of the inventive subject matter has been described with reference to specific aspects, various modifications and changes may be made to these aspects without departing from the broader scope of aspects of the present disclosure. Such aspects of the inventive subject matter may be referred to herein, individually or collectively, by the term “invention” merely for convenience and without intending to voluntarily limit the scope of this application to any single disclosure or inventive concept if more than one is, in fact, disclosed.

The aspects illustrated herein are described in sufficient detail to enable those skilled in the art to practice the teachings disclosed. Other aspects may be used and derived therefrom, such that structural and logical substitutions and changes may be made without departing from the scope of this disclosure. The Detailed Description, therefore, is not to be taken in a limiting sense, and the scope of various aspects is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, systems, engines, and data stores are somewhat arbitrary, and particular operations are illustrated in a context of specific illustrative configurations. Other allocations of functionality are envisioned and may fall within a scope of various aspects of the present disclosure. In general, structures and functionality presented as separate resources in the aspect configurations may be implemented as a combined structure or resource. Similarly, structures and functionality presented as a single resource may be implemented as separate resources. These and other variations, modifications, additions, and improvements fall within a scope of aspects of the present disclosure as represented by the appended claims. The specification and drawings are, accordingly, to be regarded in an illustrative rather than a restrictive sense.

The foregoing description, for the purpose of explanation, has been described with reference to specific aspects. However, the illustrative discussions above are not intended to be exhaustive or to limit the possible aspects to the precise forms disclosed. Many modifications and variations are possible in view of the above teachings. The aspects were chosen and described in order to best explain the principles involved and their practical applications, to thereby enable others skilled in the art to best utilize the various aspects with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present aspects. The first contact and the second contact are both contacts, but they are not the same contact.

The terminology used in the description of the aspects herein is for the purpose of describing particular aspects only and is not intended to be limiting. As used in the description of the aspects and the appended aspects, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A battery system, comprising:
a stack of lithium-ion battery cells, including two or more different thermal zones;
two or more different thermal regulating members located between battery cells in the stack of lithium-ion battery cells at dividing location between the two or more different thermal zones;
wherein the different thermal regulating members are configured to provide different heat transfer properties to adjacent different thermal zones; and
wherein opposing sides of a given thermal regulating member provide different heat transfer properties.

2. The battery system of claim 1, wherein a first thermal regulating member of the different thermal regulating members is configured to cool middle battery cells of the stack of lithium-ion battery cells faster than end battery cells.

3. (canceled)

4. The battery system of claim 1, wherein at least one of the different thermal regulating members includes an aerogel heat isolation layer.

5. The battery system of claim 1, wherein at least one of the different thermal regulating members includes a resilient layer.

6. The battery system of claim 1, further including one or more vents from a thermal zone.

7. The battery system of claim 1, wherein the stack of lithium-ion battery cells includes a stack of lithium-ion pouch battery cells.

8. A battery system, comprising:
a stack of lithium-ion battery cells, including two of more different thermal zones;
a thermal regulating member located between battery cells in the stack of lithium-ion battery cells, the thermal regulating member wherein opposing sides of a given thermal regulating member provide different heat transfer properties, each thermal regulating member further comprising:
a thermal conductor plate that forms a direct interface with only a fraction of an area of an adjacent lithium-ion battery cell; and
a heat isolation layer.

9. The battery system of claim 8, wherein the thermal conductor plate includes a pair of conductor plates over only tab regions of a lithium-ion battery cell of the stack of lithium-ion battery cells.

10. The battery system of claim 8, wherein the heat isolation layer includes an aerogel layer.

11. The battery system of claim 8, further including a heat sink coupled to a side of the stack of lithium-ion battery cells.

12. The battery system of claim 8, further including a vent coupled to a zone defined by the thermal regulating member.

13. A method of operating a battery system, comprising:
providing current to an electronic device from a stack of lithium-ion battery cells;
regulating a temperature within different portions of the stack of lithium-ion battery cells at different rates as a result of more than one different configuration of thermal conductor plate within the stack of lithium-ion battery cells; and
thermally isolating selected battery cells in the stack of lithium-ion battery cells with one or more heat isolation layer wherein opposing sides of a given heat isolation layer provide different heat transfer properties.

14. The method of claim 13, wherein regulating the temperature includes conducting heat from tab portions of one or more lithium-ion battery cells using conductor plates that include a gap over central areas of the stack of lithium-ion battery cells.

15. The method of claim 13, wherein regulating the temperature includes conducting heat from battery cells at a middle of the stack of lithium-ion battery cells faster than end battery cells.

16. A battery system, comprising:
a battery housing;
a stack of battery cells within the battery housing;
one or more extended thermal barriers between selected battery cells in the stack of battery cells wherein opposing sides of a given thermal barrier provide different heat transfer properties; and
an end plate, including one or more channels, wherein the one or more extended thermal barriers are located within the one or more channels.

17. The battery system of claim 16, wherein the one or more channels are grouped in a channel region adjacent to an extended portion of the one or more extended thermal barriers.

18. The battery system of claim 16, wherein the end plate includes a trapezoidal cross section geometry.

19. The battery system of claim 16, wherein the one or more extended thermal barriers comprise a heat insulating layer and a rigid layer, both of which are located within the one or more channels.

20. The battery system of claim 16, wherein the battery housing comprises one or more housing slots, and wherein an extended portion of the one or more extended thermal barriers is located in the one or more housing slots.
